(19) United States
(12) Patent Application Publication
(10) Pub. No.: US 2010/0154915 A1
(43) Pub. Date: Jun. 24, 2010

(54) HOSE

(76) Inventor: Chao-Chung WU, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/343,910

(22) Filed: Dec. 24, 2008

(51) Int. Cl. F16L 11/16

(52) U.S. Cl. 138/134; 138/135

(57) ABSTRACT

A hose is provided by the present invention. The hose includes a nut cap, a plastic hose and a metal spiral hose. On at least one end of the metal spiral hose is disposed an outer sleeve and an inner metal sleeve. In which, the inner metal sleeve has an initial outer diameter smaller than a bore diameter of the metal spiral hose so as to be installed therein, and the inner metal sleeve is then enlarged in a stamping manner to form an enlarged section, such that the metal spiral hose is tightly gripped between the outer and inner metal sleeves. The plastic hose is disposed in the metal spiral hose, and on at least one end of the plastic hose is disposed a positioning sleeve, so that the plastic hose is positioned between the inner metal sleeve and the positioning sleeve.

### BACKGROUND OF THE INVENTION

1. Field of the Invention

The present invention relates to a hose capable of combining with a sanitary apparatus.

2. Description of the Prior Art

As depicted in Taiwan patent, application No. 090204625, a conventional hose normally includes a metal spiral hose, a plastic hose, an outer positioning sleeve, an inner sleeve with threaded section corresponding to the spiral pattern of the metal spiral hose and a fastening head.

Practically, the inner sleeve has an outer diameter bigger than a bore diameter of the metal spiral hose, and the outer positioning sleeve is then sleeved around the metal spiral hose, such that the inner sleeve is tightly screwed in the metal spiral hose. In which, the inner sleeve should have adequate thickness to bear the positioning force without deformation. However, the bore diameter of the hose is inevitably sacrificed.

### SUMMARY OF THE INVENTION

The main object of the present invention is to provide a hose which the metal spiral hose, the inner and outer sleeves are fastened up tightly.

Another main object of the present invention is to provide a hose that a bore diameter thereof is close to or equal to that of the metal spiral hose.

To achieve the above object, a hose of the present invention includes a nut cap, a plastic hose and a metal spiral hose with two openings on both ends thereof. On at least one end of the metal spiral hose is disposed an outer sleeve and an inner metal sleeve. In which, the outer sleeve sleeves around an outer periphery of the metal spiral hose, and one end thereof proximate to the opening is radially and outwardly extended a first rim. Moreover, the inner metal sleeve has an initial outer diameter smaller than a bore diameter of the metal spiral hose so as to be installed therein, and the inner metal sleeve is then enlarged in a stamping manner to form an enlarged section, such that the metal spiral hose is tightly gripped between the outer and inner metal sleeves. Furthermore, the plastic hose is disposed in the metal spiral hose, and on at least one end of the plastic hose is disposed a positioning sleeve, so that the plastic hose is positioned between the inner metal sleeve and the positioning sleeve.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an explosive drawing showing a hose in accordance with a preferred embodiment of the present invention;

FIG. 2 is a schematic drawing showing a hose in accordance with a preferred embodiment of the present invention;

FIG. 3 is a partial profile showing a hose in accordance with a preferred embodiment of the present invention.

### DETAILED DESCRIPTION OF THE PREFERRED EMBODIMENTS

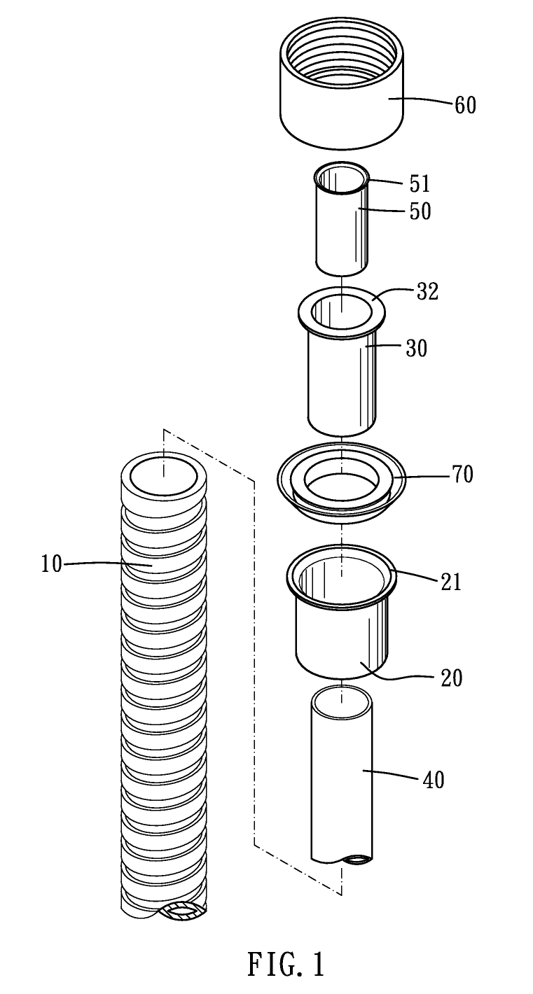

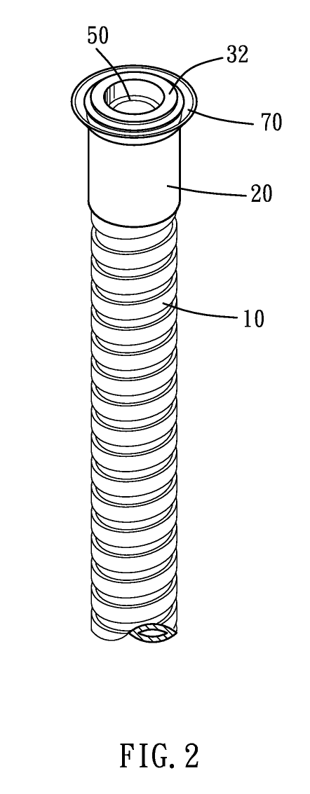

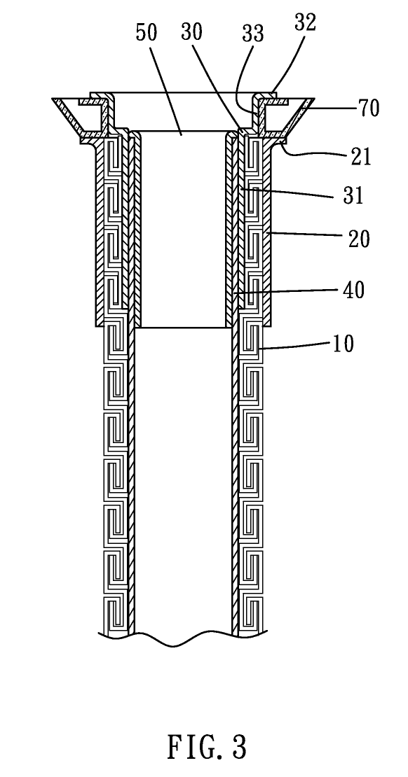

Please refer to FIG. 1 to FIG. 3. A hose includes a metal spiral hose 10 with two openings (only one of them is depicted) on both ends thereof. On at least one end of the metal spiral hose 10 is disposed an outer sleeve 20 and an inner metal sleeve 30. The outer sleeve 20 sleeves around an outer periphery of the metal spiral hose 10, and one end thereof proximate to the opening is radially and outwardly extended a first rim 21. The inner metal sleeve 30 has an initial outer diameter substantially smaller than a bore diameter of the metal spiral hose 10 so as to be installed in the metal spiral hose 10, and the inner metal sleeve 30 is then enlarged in a stamping manner to form an enlarged section 31, such that the metal spiral hose 10 is tightly gripped between the outer sleeve 20 and the inner metal sleeve 30. Because of the stamping process, the metal spiral hose 10 is also enlarged to have a larger bore diameter. In addition, it is preferred that one end of the inner metal sleeve 30 proximate to the opening is axially and outwardly extended an extended section 33, on a free end of the extended section 33 is radailly and outwardly extended a second rim 32, and the thickness of the inner metal sleeve 30 is between 0.2 mm to 0.4 mm. The material of the inner metal sleeve 30 is preferred to have greater malleability, such as copper.

The hose further includes a plastic hose 40 disposed in the metal spiral hose 10. The plastic hose 40 has two openings on both ends thereof. On at least one end of the plastic hose 40 is disposed a positioning sleeve 50, so that the plastic hose 40 is positioned between the inner metal sleeve 30 and the positioning sleeve 50. In the present embodiment, the positioning sleeve 50 is made from metal material, and the positioning sleeve 50 is also enlarged in a stamping manner to form an enlarged section, such that the plastic hose 40 is tightly gripped between the inner metal sleeve 30 and the positioning sleeve 50. Moreover, an end of the positioning sleeve 50 proximate to the opening of the plastic hose is radially and outwardly extended a third rim 51 to prevent the end of the plastic hose from exposure.

The hose further includes a nut cap 60. One end of the nut cap 60 has an inner flange with an inner diameter smaller than an outer diameter of the first rim 21 yet bigger than an outer diameter of the metal spiral hose 10, such that the nut cap 60 sleeves the outer sleeve 20 and the inner flange is hookable with the first rim 21. Another end of the nut cap 60 has a threaded section to screw with a sanitary apparatus, i.e. a shower head. In addition, an outer periphery of the extended section 33 is disposed a gasket ring 70 to from a watertight section.

Based on the above-mentioned description, it is readily to be understood that the hose of the present invention is designed to realize the follow efficacy:

1. The initial outer diameter of the inner metal sleeve is not bigger than the bore diameter of the metal spiral hose, which allows the inner metal sleeve to be installed into the hose without much effort. The inner metal sleeve is then enlarged in a stamping manner while the metal spiral hose is also enlarged during the stamping process. Therefore, the bore diameter of the hose is not sacrificed, and the mechanical strength of the hose is maintained as well.

2. To bear the pressure during the process of positioning the parts of the hose, the thickness of the inner metal sleeve of a conventional hose is increased to get better mechanic strength; on the contrary, the parts of the present invention is positioned in a stamping manner, so that the bore diameter of the hose is enlarged, the metal spiral hose, the outer and the inner metal sleeves is fastened up tightly and the thickness of the inner metal sleeve is thinner (0.2 mm to 0.4 mm) which reduces the consumption of the material, lowering the manufacturing cost.

3. The positioning sleeve can be also enlarged to form an enlarged section. Therefore, the same effect as described hereinabove can be achieved as well.

While we have shown and described various embodiments in accordance with the present invention, it should be clear to those skilled in the art that further embodiments may be made without departing from the scope of the present invention.

What is claimed is:

1. A hose, comprising
a metal spiral hose with two openings on both ends thereof, on at least one end of the metal spiral hose disposed an outer sleeve and an inner metal sleeve, the outer sleeve sleeving around an outer periphery of the metal spiral hose, and one end of the outer sleeve proximate to the opening being radially and outwardly extended a first rim, the inner metal sleeve having an initial outer diameter substantially smaller than a bore diameter of the metal spiral hose so as to be installed in the metal spiral hose, and the inner metal sleeve being then enlarged in a stamping manner to form an enlarged section, such that the metal spiral hose being tightly gripped between the outer and inner metal sleeves;
a plastic hose, disposed in the metal spiral hose, the plastic hose having two openings on both ends thereof, on at least one end of the plastic hose disposed a positioning sleeve, so that the plastic hose being positioned between the inner metal sleeve and the positioning sleeve, and
a nut cap, one end thereof being hookable with the first rim of the outer sleeve, and another end thereof having a threaded section.

2. The hose as claimed in claim 1, wherein one end of the inner metal sleeve proximate to the outer sleeve being axially and outwardly extended an extended section, on a free end of the extended section being radially and outwardly extended a second rim.

3. The hose as claimed in claim 1, wherein a thickness of the inner metal sleeve is between 0.2 mm to 0.4 mm.

4. The hose as claimed in claim 2, wherein a thickness of the inner metal sleeve is between 0.2 mm to 0.4 mm.

5. The hose as claimed in claim 1, wherein the positioning sleeve is made from metal material, and the positioning sleeve is also enlarged in a stamping manner to form an enlarged section.

6. The hose as claimed in claim 4, wherein an end of the positioning sleeve proximate to the opening of the plastic hose is radially and outwardly extended a third rim.
